(19) United States
(12) Patent Application Publication
(10) Pub. No.: US 2026/0281987 A1
(43) Pub. Date: Sep. 17, 2026

(54) AMBIENT POWER INFORMATION EXCHANGE

(71) Applicant: NXP USA, Inc., AUSTIN, TX (US)

(72) Inventors: Liwen Chu, San Ramon, CA (US); Rui Cao, Sunnyvale, CA (US); Hongyuan Zhang, Fremont, CA (US)

(21) Appl. No.: 19/554,860

(22) Filed: Mar. 3, 2026

Related U.S. Application Data
(60) Provisional application No. 63/769,812, filed on Mar. 11, 2025.

(51) Int. Cl. H04W 72/0446; H04L 1/00; H04W 84/12

(52) U.S. Cl. CPC H04W 72/0446; H04L 1/0061; H04W 84/12

(57) ABSTRACT

An information exchange comprises transmitting, by the AP, a first PPDU with a broadcast trigger frame indicating for the station to indicate presence of the station to the AP in a slot of one or more slots announced by the broadcast trigger frame in the first PPDU; receiving, by the AP, an indication of the presence of the station in a selected slot of the first PPDU; transmitting, by the AP and based on the indication of presence, a second PPDU to the station with a soliciting frame indicating for the station to perform an operation and transmit a frame in response to performing the operation in an allocated slot of the second PPDU; and receiving, by the AP, the frame in the allocated slot of the second PPDU from the station.

### CROSS-REFERENCE TO RELATED APPLICATIONS

This application claims priority under 35 U.S.C § 119 to the benefit of U.S. Provisional Patent Application Serial Number 63/769812 titled “AMP INFORMATION EXCHANGE” which was filed Mar. 11, 2025, the contents of which are incorporated herein by reference in its entirety.

### FIELD OF USE

The present disclosure relates generally to data communication, and more particularly, to a system, method, and apparatus for information exchange during ambient power communication between an ambient power (AMP) reader and AMP tag device based on Institute of Electrical and Electronics Engineers (IEEE) 802.11bp.

### BACKGROUND

Ambient power (AMP) communication proposed by Institute of Electrical and Electronics Engineers (IEEE) 802.11.bp defines a protocol for communication between an access point (AP) having an AMP reader and an AMP tag device which does not have a battery in a sub 1 GHz and 2.4 GHz range of an 802.11 network. The AMP tag device supports radio frequency (RF) harvesting in lieu of having the battery and is able to coexist with legacy 802.11 WiFi stations. The AMP tag device communicates with the AMP reader by reflecting and modulating radio waves emitted by the AMP reader (backscatter).

### BRIEF DESCRIPTION OF THE DRAWINGS

The following detailed description of the preferred embodiments of the present disclosure will be better understood when read in conjunction with the appended drawings. The present disclosure is illustrated by way of example, and not limited by the accompanying figures, in which like references indicate similar elements.

FIG. 1 illustrates an example block diagram of an ambient power (AMP) communication system in accordance with one or more embodiments.

FIG. 2 illustrates example communication between an access point (AP) and station to perform an information exchange in accordance with one or more embodiments.

FIG. 3 illustrates example communication between the AP and station to perform a read operation in accordance with one or more embodiments.

FIG. 4 illustrates example communication between the AP and station for performing an authentication operation in accordance with one or more embodiments.

FIG. 5 illustrates example communication between the AP and station for performing a write operation in accordance with one or more embodiments.

FIG. 6 illustrates an example flow chart of functions associated with exchanging information between an AP and station in accordance with one or more embodiments.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

Embodiments disclosed herein are directed to information exchange between an access point (AP) having an ambient power (AMP) reader and a station (station) having an AMP tag device that communicate frames via backscattering in a slot of a physical layer protocol data unit (PPDU). The AP and station are able to co-exist with legacy WiFi devices in a WiFi network. Well known instructions, protocols, structures, and techniques have not been shown in detail in order not to obfuscate the description.

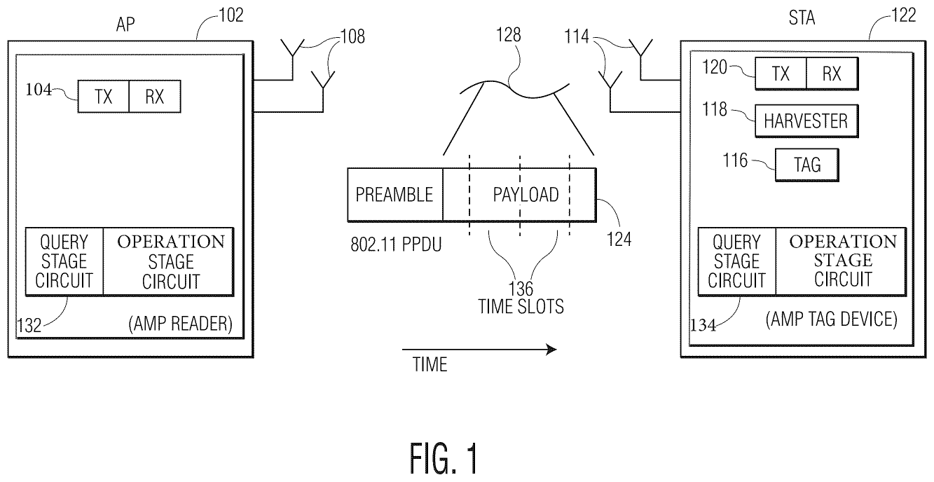

FIG. 1 illustrates an example block diagram of an ambient power (AMP) communication system 100 in accordance with one or more embodiments. The AMP communication system 100 may include a station (STA) 122 and an access point (AP) 102. The communication system 100 illustrates one AP 102 and one station 122 but in other arrangements the communication system 100 may generally have one or more AP 102 and one or more stations 122 which are associated or unassociated with a respective AP. The AP 102 may facilitate communication between the station 122 and a wired local area network (WLAN) using radio technology. In an embodiment, the station (STA) 122 is a fixed or mobile wireless terminal and the AP 102 may be a networking device which facilitates connecting the station to a wired network (not shown) 102 by a wireless connection. The AP 102 and station 122 may be compliant with various iterations of Institute of Electrical and Electronics Engineers (IEEE) 802.11 WiFi protocol, specifically, but not limited to IEEE 802.11b, IEEE 802.11ac referred to as very high throughput (VHT), IEEE 802.11ax referred to as high efficiency (HE), IEEE 802.11be referred to as extreme high throughput (EHT), and IEEE 802.11bn referred to as ultra-high reliability (UHR). The AP 102 may further include an ambient power (AMP) reader and an AMP tag device which are compliant with IEEE 802.11bp (“AMP protocol”). The AMP reader emits signals compliant with the AMP protocol to communicate and capture data to/from the station 122. The AMP tag device may be a battery-less device powered by a received signal which stores data communicated by the AP 102 and data to be communicated with the AP 102 by the AMP protocol. In an embodiment, IEEE 802.11ac, IEEE 802.11ax, IEEE 802.11be, IEEE 802.11bn may be referred to herein as legacy WiFi protocols while 802.11bp may be referred to herein as the AMP protocol. The AP 102 and station 122 may be implemented by one or more of analog circuitry, mix signal circuitry, memory circuitry, logic circuitry, and processing circuitry that executes code stored in a memory to perform disclosed functions by one or more integrated circuits.

In one or more embodiments, the station 122 may be operable in one or more sub-bands, such as sub-1 GHz and 2.4 GHz and have one or more antenna 114 for transmitting or receiving signals in the band. The AMP tag device of the station 122 may have an integrated circuit (IC) 120 having a transmitter circuit and receiver circuit to facilitate transmitting or receiving signals and processing circuitry (not shown) for performing described functions. The received signal may indicate a request from the AP 102 to authenticate the station 122, read or write data from/to a memory of the station 122 also referred to a tag 116 which is a non-volatile memory and the transmitted signal may indicate data stored in the tag 116 as a result of the read request or be an acknowledgement response to the write request. The station 122 which is a battery-less device may also have a harvester 118 which extracts power from a waveform 128 compliant with the AMP protocol transmitted by the AP 102 and incident on the antenna 114 which is used to operate the integrated circuit (IC) 120 to receive and transmit signals. In one or more embodiments, the waveform 128 may be or include a carrier waveform or energizing waveform on which the data transmitted by the AP 102 is modulated, and on which the station 122 backscatters data by modulation to define the signals transmitted by the station 122 to the AP 102.

In one or more embodiments, the AMP reader of the AP 102 may have an integrated circuit 104 having a transmitter and receiver and one or more antenna 108 to transmit and receive IEEE 802.11bp (AMP compliant) signals. To achieve co-existence with other legacy WiFi devices (e.g., devices which do not support IEEE 802.11bp communication), the waveform 128 transmitted to the station 122 may take the form of a physical layer protocol data unit (PPDU) 124 having symbols that represent one or more bits that define a legacy WiFi preamble, e.g., 802.11b or legacy orthogonal frequency division multiplexed (OFDM) preamble (e.g., 802.11 11g/n/ac/ax/be) and a payload of the PPDU. By defining the waveform 128 to have the legacy preamble, the PPDU 124 is configured to allow other legacy WiFi devices (not shown and not AMP compliant) to be able to decode the legacy preamble of the PPDU 124 and backoff from transmitting for the duration of the PPDU 124 as indicated by the legacy preamble so as not to interfere with communication between the AMP reader of the AP 102 and the AMP tag device of the station 122 compliant with the AMP protocol.

In one or more embodiments, the AP 102 may authenticate the station 122, read data from the station 122 or write data to the station 122 based on transmission of the PPDU 124. The PPDU 124 transmitted as the waveform 128 is incident on the antenna 114 of the station 122. The harvester 118 of the station 122 may harvest power from the waveform 128 defining the PPDU 124 to power the IC 120 to receive and decode symbols in the payload of the PPDU 124. Based on the symbols that are decoded in the PPDU 124, the IC 120 may cause the station 122 to perform a read or write request and transmit a response or authenticate itself. The response for the write request may be an acknowledgment that the write request is completed and the response of the read request may be an indication of the data read. The response of the write request or read request may also be a reject of the request that indicates the failure of the operation and the reason of the failure. The station 122 may transmit the response by a backscattering process which involves modulating a portion of the waveform 128 incident on the antenna 114 to generate a backscatter signal. Impedance of the antenna 114 may be modulated based on bits of the response to modulate an amount of incident RF energy and scatter the amount of incident energy on the antenna 114 to transmit bits of the response from the station 122 to the AP 102 as backscattering. The AP 102 will then receive this backscatter signal. In some embodiments, the AP 102 may further send an acknowledgement to indicate the receipt of the response or uplink communication.

Embodiments disclosed herein are directed to a method and system for the station 122 to transmit one or more frames (i.e., information exchange) to the AP 102 based on a time-slot based communication protocol in a transmit opportunity (TXOP). A frame may be a unit of data transmission having a header and payload. The TXOP may be a time granted by the AP 102 to the station 122 for communication of the PPDU 124 from the AP 102 to the station 122. To facilitate transmission of the frames, the payload of the PPDU 124 may be subdivided into a plurality of time slots 136 which are each a fixed length time. The timing of the slots may be predefined by the AP 102 and station 122. In some embodiments, the fixed length time may be the same for the plurality of time slots 136 as shown or may vary for the plurality of time slots 136. In some embodiments, the payload of the PPDU 124 may be divided to have only one time slot. A station 122 which wants to transmit a signal to the AP 102 may need to wait for a beginning of a time slot of the plurality of time slots 136 in a payload of the PPDU 124 before being allowed to transmit a frame in the selected time slot by backscattering to the AP 102. In some embodiments, the frame may be transmitted in one or more time slots. The plurality of time slots 136 which the station 122 is to use for transmitting the frame may be defined by a query stage and an operation stage. The query stage allows for the AP 102 to identify a station 122 which is to communicate with the AP 102 while the operation stage may allow for the AP 102 to perform a request with the station 122 such as the read request, write request, or authentication request to exchange information between the AP 102 and the station 122. The AP 102 and station 122 may have a respective information exchange circuit 132, 134 that implements processing for the query stage and an operation stage by a query stage circuit and operation stage circuit, respectively.

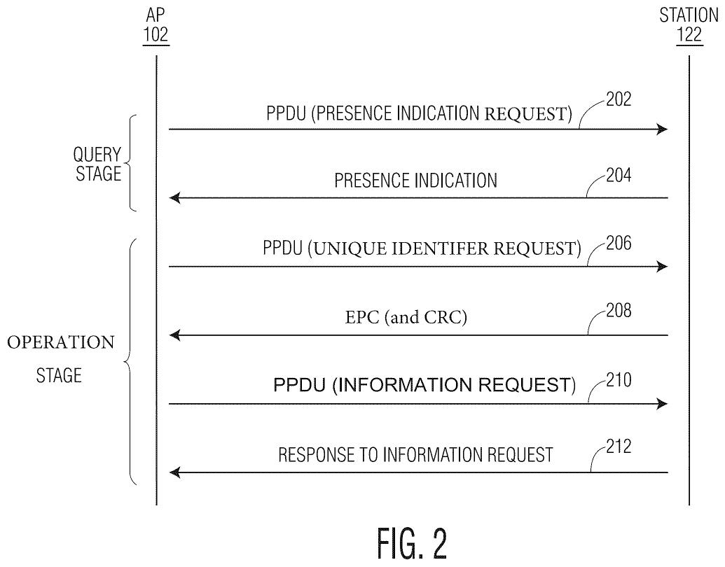

FIG. 2 illustrates example communication between the AP 102 and station 122 to perform the information exchange in accordance with one or more embodiments. In an embodiment, the communication may begin in a query stage. At 202, the AP 102 may transmit (i.e., broadcast) a PPDU which announces one or more time slots which the station 122 is able to select from to communicate with the AP 102. The broadcast trigger frame also carries a threshold where the station 122 uses the threshold to decide whether the station 122 will use a slot of the slot(s) announced by the broadcast trigger frame to transmit a frame. The broadcast trigger frame may also carry an indication of a range with the threshold being within the range and where the station 122 has a random number generator to generate a random number that is within the range. A variant is that the threshold and/or range are selected by the station 122 instead of being carried in the broadcast Trigger frame. In an embodiment, the broadcast may be received and decoded by a plurality of stations. In an embodiment, the announcement may take the form of a broadcast frame in the PPDU which indicates one or more of a start and stop of each time slot of a plurality of time slots in the payload of the PPDU and a request for a station to indicate its presence to the AP 102. Each station which receives the PPDU such as station 122 may then transmit at 204 a station identifier in a slot to identify its presence to the AP 102 based on a backscattering process. The station identifier may be a 16 bit random number or a 16 bit cyclic redundancy check (CRC) applied to an electronic product code (EPC) of the station 122 where the EPC is a unique identifier of the station 122. In one embodiment, the PPDU may announce one time slot to transmit. The station 122 may identify the time slot in the PPDU and determine whether to use the time slot to transmit. In an embodiment, the station 122 may generate a random number within the range using a random number generator to determine whether to use the slot to transmit. For example, the random number may be a number less than the range (e.g., 1 to 16) and the threshold (e.g., 12) may be a value in the range. If the random number is less than the threshold, the station 122 may use the slot to transmit the station identifier to the AP 102 in a frame of the PPDU, otherwise the slot is not used. Alternatively, if the random number is greater than the threshold, the station 122 may use the slot, otherwise the slot is not used. If the broadcast Trigger announces one slot, the station stops the random access procedure whether or not the slot is used. If the broadcast Trigger announces multiple slots and the station cannot access one slot, the station repeats such procedure for the following slot until the last slot. In another embodiment, the PPDU may announce more than one time slot that the station 122 is able to use to transmit the indication of the presence. The announcement of more than one slot for transmission requires increased synchronization and reduced clock drift between clocks of the AP 102 and station 122 so that the station 122 may resolve timing between different time slots. The station 122 may define a threshold and generate a random number to determine whether to use a first slot to transmit the station identifier) to the AP 102. For example, the random number may be a number in a range (e.g., 1 to 16) and the threshold (e.g., 12) may be a value in the range. If the random number is less than the threshold, the station 122 may select the first slot to transmit the station identifier in a frame of the PPDU and stop contending for additional slots. Otherwise, the station 122 may not select the first slot to transmit its station identifier and a random number is generated for a second slot to determine whether to select the second slot to transmit the station identifier similar to the determination performed for the first slot. This process is repeated for each slot of the plurality of slots until a slot is selected to transmit the frame or no more slots are available for transmission in the PPDU.

The station identifier which takes the form of the 16 bit CRC or 16 bit random number to the AP 102 identifies presence of the station 122 to the AP 102 if no other station selects the same slot to transmit in the query stage. In an embodiment, using the random number to identify the station 122 is preferable compared to the CRC to avoid different stations 122 generating a same CRC based on its associated EPC and the station identifier not able to uniquely identify the station 122 using the CRC.

In an operation stage which follows the query stage, the AP 102 allocates a time slot in another PPDU for the station 122 to transmit or receive information if no other station selected the same slot to transmit its random number or CRC in the query stage. The AP 102 may unicast a soliciting frame to the station 122 in the other PPDU to perform an operation and receive from the station 122 a frame in response to the operation. This process of soliciting an operation (e.g., by a trigger frame) and receiving the response may be repeated one or more times with the station 122. In an embodiment, the AP 102 may issue a unique identifier request to obtain a unique identifier of the station such as its EPC and CRC followed by sending a read request, authentication request, or write request to the station 122.

At 206, the AP 102 transmits (unicast) in the other PPDU a frame with the station identifier identified in a header of the frame to indicate the recipient of the frame and an indication of a slot allocated to the station associated with the station identifier. The frame of the other PPDU may also include a query of the EPC of the station which uniquely identifies the station 122 compared to the CRC or random number. The CRC may also be queried if not provided as the station identifier at 204. In an embodiment, the unicast transmission may be received and decoded by the station with the station identifier. At 208, the station 122 identified by the CRC or the random number then transmits by backscattering in a frame of the other PPDU the EPC (and CRC) of the station 122 in the slot that the AP 102 allocates to the station 122.

In one or more embodiments, the AP 102 may transmit one or more requests to the station 122 such as a read request, authentication request, or write request. At 210, the AP 102 may transmit (unicast) a PPDU to the station 122 having a frame which indicates that the station 122 is to perform a request indicated by the AP 102. A frame of the PPDU may have an indication of the station identifier, e.g., CRC or random number, of the station 122 in a header which causes the station 122 to determine that the request is directed to the station 122. For example, the request may be a read of information stored in the tag 116 of the station 122, authentication of the station 122, or write of information to the tag 116 of the station 122. Further, the request may indicate to the station 122 a slot for the station 122 to provide a response to the request. The station 122 may transmit a frame with the response to the request at 212 in the slot by backscattering. For a read request, the station 122 may transmit the read information stored in the tag 116. For an authentication request, the station 122 may transmit an authentication response to the AP 102 in the PPDU. For a write request, the station 122 may transmit an acknowledgment if the write request is successful or a negative acknowledgement of the write request is not successful and a reason. In one or more embodiments, the AP 102 may transmit different PPDUs to perform different requests with the station 122.

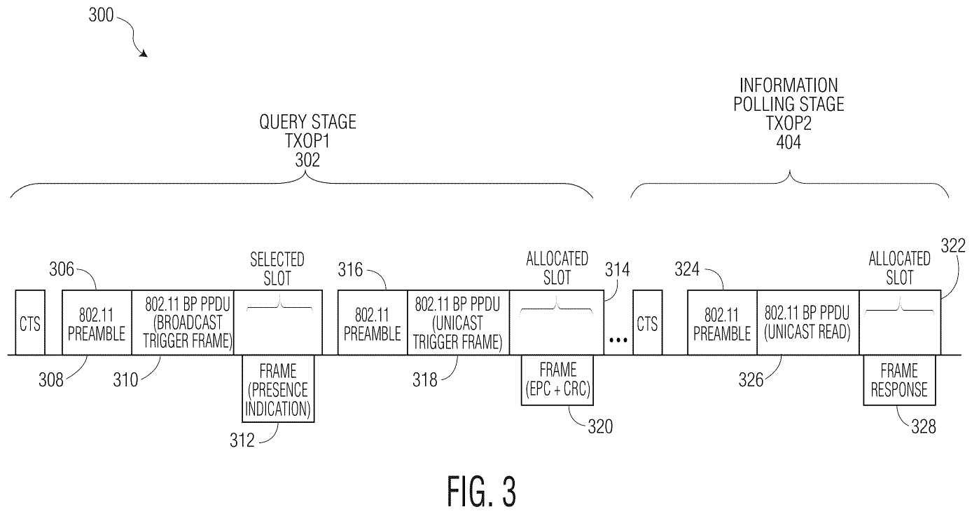

FIG. 3 illustrates example communication 300 between the AP 102 and station 122 to perform the read operation in accordance with one or more embodiments. The AP 102 may transmit one or more PPDUs to the station 122 in one or more TXOP to perform the read operation. The read operation may begin in a first TXOP 302 by the AP 102 transmitting a PPDU carrying a clear to send (CTS) and a PPDU 306 defined by IEEE 802.11 (WiFi) that follows the PPDU carrying CTS. The CTS is used to protect the Query stage TXOP1 302 from interfering transmission by other devices. The PPDU 306 may include an 802.11 PHY preamble 308 for synchronization and payload where the 802.11 PHY preamble 308 may allow legacy 802.11 WiFi devices that do not support AMP protocol to decode the PPDU 306 and refrain from transmitting until the end of the PPDU 306. The AP 102 may include in the payload of the PPDU an 802.11bp PPDU 310 carrying a broadcast trigger frame which announces for the stations including the station 122 to transmit an indication of presence of the station 122 to the AP 102 in a slot of one or more slots in the payload of the PPDU 306. The broadcast trigger frame also carries a threshold where the station 122 uses the threshold to decide whether the station 122 will use a slot of the slot(s) announced by the broadcast trigger frame to transmit a frame. The broadcast trigger frame may also carry an indication of a range with the threshold being within the range and where the station 122 generates the random number that is within the range. A variant is that the threshold and/or range are selected by the station 122 instead of being carried in the broadcast Trigger frame. The station 122 may randomly decide to select a slot and transmit in the slot of the PPDU 306 by backscattering a frame 312 which indicates the station identifier of the station 122 indicating a presence. The random access procedure is defined as the following. For each slot announced by the broadcast Trigger frame, the station 122 generates a random value within the range to compare the value with the threshold carried in the broadcast Trigger frame. If the random value is less than the threshold, the station 122 uses this slot transmit its frame and then stops the random access procedure. Otherwise, the station 122 may try to use a following slot announced by the AP 102 until a last slot to transmit the frame. The station identifier may be a random number or CRC of the EPC of the station 122 which is received by the AP 102. The AP 102 may then transmit a PPDU 314 with an 802.11 PHY preamble 316 having in the payload an 802.11bp PPDU 318. The PPDU 318 may have a trigger frame with a header that includes the station identifier of the station 122 (unicast to the station 122) and which queries the station 122 for its EPC (and CRC) to be transmitted in an allocated slot in the payload of the PPDU 314. The station 122 may then transmit in the allocated slot of the PPDU 314 a frame 320 carrying the EPC (and CRC) of the station 122 to the AP 102. The AP 102 may then perform the read request in another TXOP 304. In some embodiments, the TXOP1 and TXOP 2 may be separated by a time illustrated by “. . . ” which indicates a variable duration of time when the medium could be idle or other devices are transmitting or receiving in a TXOP before the TXOP 2 begins. The AP 102 may transmit a PPDU carrying CTS to protect the TXOP and a PPDU 322 with a 802.11 preamble 324 and payload having an 802.11bp PPDU 326 with a frame unicast to the station 122, i.e. the header of the frame identifying the station 122 by the station identifier, e.g., CRC or random number, in the frame header. The 802.11bp PPDU may further indicate in the frame body a read request to be performed by the station 122 and slot allocated to the station 122 in the payload of the PPDU 322 to provide results of the read request by backscattering. The station 122 may perform the read request and then transmit in the allocated slot of the PPDU 322 by backscattering a frame response 328 indicating the read data. In some embodiments, the response to the read request may indicate an unsuccessful read if the read request can't be finished. Otherwise the information being read is carried in the response.

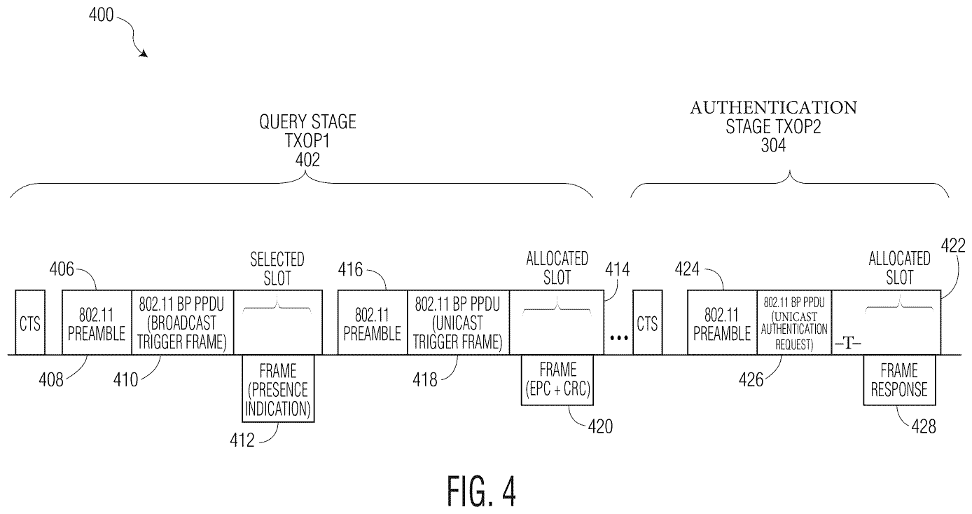

FIG. 4 illustrates example communication 400 between the AP 102 and station 122 for performing an authentication operation in accordance with one or more embodiments. The AP 102 may transmit one or more PPDUs to the station 122 in one or more TXOP to perform the authentication operation. The authentication request may begin in a first TXOP 402 by the AP 102 transmitting a PPDU carrying CTS and a PPDU 406 defined by IEEE 802.11 (WiFi) that follows the PPDU carrying the CTS. The CTS is used to protect the Query stage TXOP1 402. The PPDU 406 may comprise an 802.11 PHY preamble 308 for synchronization and payload where the 802.11 PHY preamble 408 may allow legacy 802.11 WiFi devices that do not support AMP protocol to decode the PPDU 406 and refrain from transmitting until the end of the PPDU 406. The AP 102 may include in the payload of the PPDU an 802.11bp PPDU 410 carrying a broadcast trigger frame which announces for the stations including the station 122 to randomly decide to transmit an indication of presence of the station 122 to the AP 102 in a slot of one or more slots in the payload of the PPDU 406. The broadcast trigger frame also carries a threshold where the station 122 uses the threshold to decide whether the station 122 will use a slot of the slot(s) announced by the broadcast trigger frame to transmit a frame. The broadcast trigger frame may also carry an indication of a range with the threshold being within the range and where the station 122 generates the random number that is within the range. A variant is that the threshold and/or range are selected by the station 122 instead of being carried in the broadcast Trigger frame. The station 122 may randomly select a slot and transmit in the slot of the PPDU 406 by backscattering a frame 412 carrying the station identifier of the station 122. The random access procedure is defined as the following. For each slot announced by the broadcast Trigger frame, the station 122 generates a random value within the range to compare the value with the threshold carried in the broadcast Trigger frame. If the random value is less than the threshold, the station 122 uses this slot transmit its frame and then stops the random access procedure. Otherwise, the station 122 may try to use a following slot announced by the AP 102 until a last slot to transmit the frame. The station identifier may be a random number or CRC of the EPC of the station 122 which is received by the AP 102. The AP 102 may then transmit a PPDU 414 with an 802.11 PHY preamble 416 having in the payload an 802.11bp PPDU 418 and the slot carrying the frame 420. The PPDU 418 may have a trigger frame with a frame header that carries the station identifier of the station 122 (unicast to the station 122) and which queries the station 122 for its EPC (and CRC) to be transmitted in an allocated slot in the payload of the PPDU 414. The station 122 may then transmit in the allocated slot in the payload of the PPDU 414 a frame 420 carrying the station identifier, e.g., EPC (and CRC), of the station 122 to the AP 102. The AP 102 may then transmit an authentication request in another TXOP 404. In some embodiments, the TXOP1 and TXOP 2 may be separated by a time illustrated by “. . . ” which indicates a variable duration of time when the medium could be idle or other devices are transmitting or receiving in a TXOP before the TXOP 2 begins. The AP 102 may transmit a PPDU carrying CTS to protect the TXOP and a PPDU 422 with a 802.11 preamble 424 and payload having an 802.11bp PPDU 426 with a frame unicast to the station 122, i.e., a header of the frame identifying the station 122 by the CRC or random number in the frame header. The 802.11bp PPDU 422 may further indicate in the frame body the authentication request to be performed by the station 122 and slot in the payload of the PPDU 422 allocated to the station 122 to provide results of the authentication request by backscattering. The station 122 may perform the authentication request and then transmit in the allocated slot of the PPDU 422 by backscattering a frame 428 indicating the authentication response. In an embodiment, the AP 102 may allocate a particular slot in the PPDU 422 such that a time T between transmission of the request 426 and backscatter transmission of the response in the frame 428 is sufficient for the station 122 to determine the authentication response. In some embodiments, the response to the authentication request may indicate an unsuccessful authentication if the authentication request is not able to be finished. Otherwise, the authentication result is carried in the response.

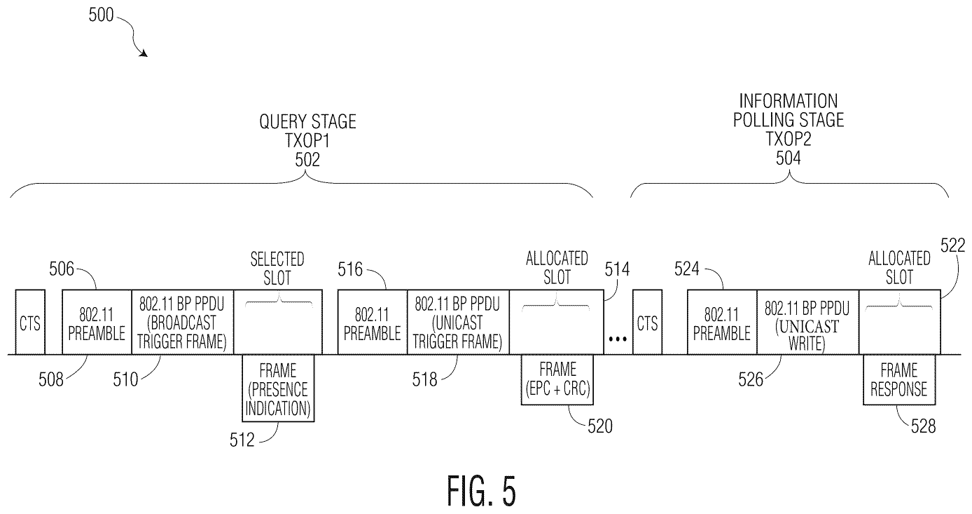

FIG. 5 illustrates example communication 500 between the AP 102 and station 122 for performing a write operation in accordance with one or more embodiments. The AP 102 may transmit one or more PPDUs to the station 122 in one or more TXOP to perform the write operation. The write operation may begin in a first TXOP 502 by the AP 102 transmitting a PPDU carrying CTS and a PPDU 506 defined by IEEE 802.11 (WiFi) that follows the PPDU carrying CTS. The CTS is used to protect the Query stage TXOP1 302. The PPDU 506 may comprise an 802.11 PHY preamble 508 for synchronization and payload where the 802.11 PHY preamble 508 may allow legacy 802.11 WiFi devices that do not support AMP protocol to decode the PPDU 506 and refrain from transmitting until the end of the PPDU 506. The AP 102 may include in the payload of the PPDU 506 an 802.11bp PPDU 510 carrying a broadcast trigger frame which announces for the stations including the station 122 to transmit an indication of presence of the station 122 to the AP 102 in a slot of one or more slots in the payload of the PPDU 506. The broadcast trigger frame also carries a threshold where the station 122 uses the threshold to decide whether the station 122 will use a slot of the slot(s) announced by the broadcast trigger frame to transmit a frame. The broadcast trigger frame may also carry an indication of a range with the threshold being within the range and where the station 122 generates the random number that is within the range. A variant is that the threshold and/or range are selected by the station 122 instead of being carried in the broadcast Trigger frame. The station 122 may randomly decide to select a slot and transmit in the slot of the PPDU 506 by backscattering a frame 512 that carries the station identifier of the station 122. The random access procedure is defined as the following. For each slot announced by the broadcast Trigger frame, the station 122 generates a random value to compare the value with the threshold carried in the broadcast Trigger frame. If the random value is less than the threshold, the station 122 uses this slot transmit its frame and then stops the random access procedure. Otherwise, the station 122 may try to use a following slot announced by the AP 102 until a last slot to transmit the frame. The station identifier may be a random number or CRC of the EPC of the station 122 which is received by the AP 102. The AP 102 may then transmit a PPDU 514 with an 802.11 PHY preamble 516 having in the payload an 802.11bp PPDU 518. The PPDU 518 may have a trigger frame with a frame header that includes the station identifier of the station 122 (unicast to the station 122) and which queries the station 122 for its EPC (and CRC) to be transmitted in an allocated slot in the payload of the PPDU 514. The station 122 may then transmit in the allocated slot in the payload of the PPDU 514 a frame 520 carrying the EPC (and CRC) of the station 122 to the AP 102. The AP 102 may then perform the write request in another TXOP 504. In some embodiments, the TXOP1 and TXOP 2 may be separated by a time illustrated by “. . . ” which indicates a variable duration of time when the medium could be idle or other devices are transmitting or receiving in a TXOP before the TXOP 2 begins. The AP 102 may transmit a PPDU carrying a CTS to protect the TXOP and a PPDU 522 with an 802.11 preamble 324 and payload having an 802.11bp PPDU 526 with a frame unicast to the station 122, i.e., the header of the frame identifying the station 122 by the station identifier, e.g., CRC or random number. The 802.11bp PPDU 526 may further indicate in the frame body the write request to be performed by the station 122 and slot in the payload of the PPDU 526 allocated to the station 122 to provide results of the write request. The station 122 may perform the write request and then transmit in the allocated slot of the PPDU 522 by backscattering a frame 528 carrying a positive acknowledgment if the write is successful or a negative acknowledgment with a reason if the write request is not successful.

The AP 102 may request that the station 122 perform a plurality of read, write, authentication, or other operations. For example, the AP 102 may transmit the PPDU 322 in another TXOP to perform another read operation with the station 122 after the TXOP. As another example, the AP 102 may transmit the PPDU 522 in another TXOP to perform another write operation with the station 122 after the TXOP. Further, after presence of the station 122 is made known by the PPDU 306, 506, the AP 102 may transmit PPDUs corresponding to different types of operations in succession in a respective TXOP without having to send a PPDU 306, 506 to identify the station 122.

In some embodiments, a broadcast trigger frame can only allocate one slot for the stations to randomly decide to send their station identifiers. The broadcast Trigger frame also carries a threshold where the stations use the threshold to decide whether they will use the slot announced by the broadcast Trigger frame to transmit its frame. The broadcast Trigger frame may also carry a range with the threshold being within the range where the stations generate the random number that is no more or less than the range. A variant is that the threshold and/or range are selected by the stations instead of being carried in the broadcast Trigger frame. The station may randomly decide to select a slot and transmit in the slot of the PPDU by backscattering a frame that carries the station identifier of the station or other information. The random access procedure is defined as the following. For the slot announced by the broadcast Trigger frame, the station generates a random value to compare the value with the threshold carried in the broadcast Trigger frame. If the random value is less than the threshold, the station uses this slot transmit its frame and then stops the random access procedure. Otherwise, the station stops the random access procedure without using the slot. In some embodiments, a single broadcast trigger frame announcing only one slot is applied to a mono-static backscatter use case (e.g., transmit and receive antenna in a same location/device). Monostatic backscatter is a low-power wireless communication technology where a single, collocated reader/transmitter sends a radio frequency (RF) signal to a passive tag, which then modulates and reflects this signal back to the same device. In some embodiments, a broadcast trigger frame can allocate multiple slots for the stations to randomly decide to send their station identifiers. The broadcast Trigger frame also carries a threshold where the stations use the threshold to decide whether they will use the slot(s) announced by the broadcast Trigger frame to transmit its frame. The broadcast Trigger frame may also carry a range with the threshold being within the range where the stations generate the random number that is no more than or no less than the range. A variant is that the threshold and/or range are selected by the stations instead of being carried in the broadcast Trigger frame. The station may randomly decide to select a slot and transmit in the slot of the PPDU by backscattering a frame that carries the station identifier of the station or the other information. The random access procedure is defined as the following. For each slot announced by the broadcast Trigger frame, the station generates a random value to compare the random value with the threshold carried in the broadcast Trigger frame. If the random value is less than the threshold, the station uses this slot transmit its frame and then stops the random access procedure. Otherwise, the station may try a following slot announced by the AP to transmit the frame until a last slot. In some embodiments, a single broadcast trigger frame announcing the multiple slots is applied to the use cases other than the mono-static backscatter use case.

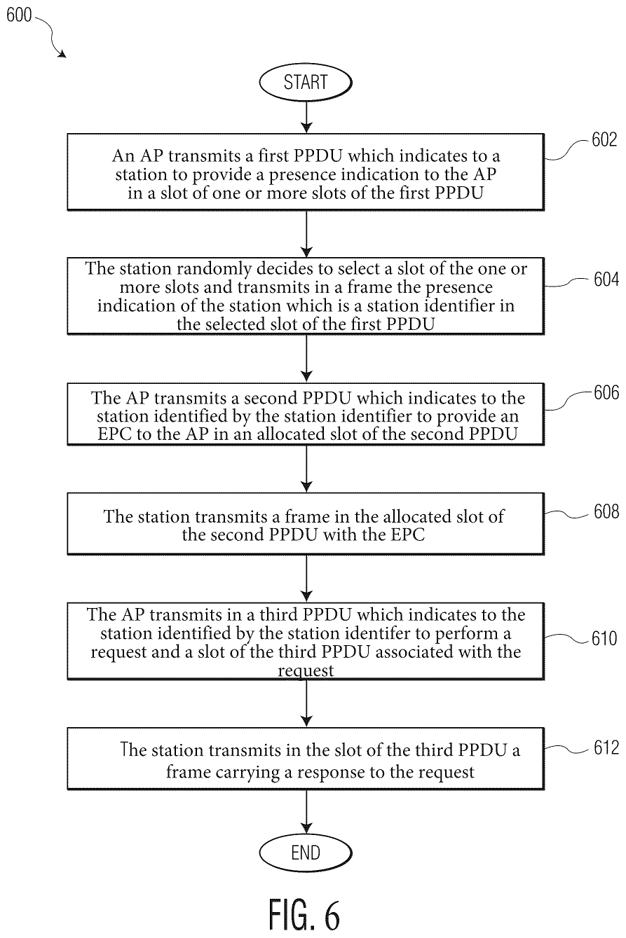

FIG. 6 illustrates an example flow chart 600 of functions associated with exchanging information between an AP 102 and station 122 in accordance with one or more embodiments. The functions may be performed by one or more of the AP 102 and station 122 in an embodiment.

At 602, an AP transmits a first PPDU which indicates to a station to provide a presence indication to the AP in a slot of one or more slots of the first PPDU. The first PPDU may be transmitted in a first TXOP and may have a broadcast trigger frame which carries the indication. The broadcast trigger frame also carries a threshold where the station uses the threshold to decide whether the station will use a slot of the slot(s) announced by the broadcast trigger frame to transmit a frame. The broadcast trigger frame may also carry an indication of a range with the threshold being within the range and where the station generates the random number that is within the range. A variant is that the threshold and/or range are selected by the station instead of being carried in the broadcast Trigger frame. At 604, the station randomly decides to select a slot of the one or more slots and transmits in a frame the presence indication of the station in the selected slot of the first PPDU. The random access procedure is defined as the following. For each slot announced by the broadcast Trigger frame, the station generates a random value to compare the random value with the threshold carried in the broadcast Trigger frame. If the random value is less than the threshold, the station uses this slot transmit its frame and then stops the random access procedure. Otherwise the station may use a following slot announced by the AP until a last slot. The indication may be a station identifier such as a random number or CRC of the EPC of the station based on the AP not being associated with the station. At 606, the AP transmits a second PPDU which indicates to the station to provide an EPC to the AP in an allocated slot of the second PPDU. The second PPDU may be transmitted in the first TXOP and may have a unicast trigger frame to indicate by the station identifier for the station to transmit the EPC in the allocated slot. In some embodiments, the station may also transmit the CRC if not previously transmitted as a station identifier. At 608, the station transmits a frame in the allocated slot of the second PPDU with the EPC and CRC. At 610, the AP transmits in a third PPDU which indicates to the station identified by the station identifier to perform a request and a slot of the third PPDU associated with the request. The third PPDU may be transmitted in a second TXOP and may have a unicast trigger frame which carries the indication of the request and slot. The request may be a request to perform a read request, write request, or authentication request. At 612, the station transmits in the slot of the third PPDU a frame carrying a response to the request. The response may be data read for a read request, an acknowledgement or negative acknowledgement for a write request, or an authentication response to the authentication request in one or more embodiments.

In one or more embodiments, a method for information exchange by an access point (AP) and station operating in accordance with Institute of Electrical and Electronics Engineers (IEEE) 802.11bp is disclosed. The method comprises: transmitting, by the AP, a first PPDU with a broadcast trigger frame indicating for the station to indicate presence of the station to the AP in a slot of one or more slots announced by the broadcast trigger frame in the first PPDU; receiving, by the AP, an indication of the presence of the station in a selected slot of the first PPDU; transmitting, by the AP and based on the indication of presence, a second PPDU to the station with a soliciting frame indicating for the station to perform an operation and transmit a frame in response to performing the operation in an allocated slot of the second PPDU; and receiving, by the AP, the frame in the allocated slot of the second PPDU from the station. In an embodiment, transmitting, by the AP, the second PPDU to the station comprises transmitting, by the AP, the second PPDU to the station with the trigger frame indicating for the station to transmit an indication of an electronic product code (EPC) of the station in the allocated slot of the second PPDU based on the indication of presence and receiving by the AP the frame comprises receiving, by the AP, the EPC of the station in the frame of the allocated slot of the second PPDU; the method further comprising: transmitting, by the AP, a third PPDU with an indication for the station to perform an information request and an indication of an allocated slot in the third PPDU; and receiving, by the AP, a response to the information request in the allocated slot of the third PPDU. In an embodiment, the information request is one or more of a write request, read request, and authentication request. In an embodiment, the information request is a write request and the response to the information request being performed is an acknowledgment that the write request is performed or a negative acknowledgment that the write request is not performed and a reason that the write request is not performed. In an embodiment, the indication of presence of the station is a 16 bit random number selected by the station or a 16 bit cyclic redundancy check (CRC) of an EPC identifying the station transmitted in the selected slot by a backscattering process. In an embodiment, the method further comprises the station randomly deciding to select the slot of the one or more slots indicated by the AP based selecting a random number in a range defined by the first PPDU and comparing the random number to a threshold defined by the first PPDU, the slot being in a first TXOP. In an embodiment, the second PPDU comprises an IEEE 802.11 preamble and a payload having an IEEE 802.11bp PPDU carrying the trigger frame having a station identifier of the station in a header of the trigger frame to facilitate unicast of the trigger frame to the station. In an embodiment, the station identifier in the header of the trigger frame is a CRC or a random number. In an embodiment, the AP and the station are unassociated as defined by an IEEE 802.11 (WiFi) association process. In an embodiment, the first PPDU and the second PPDU are transmitted in a first transmit opportunity (TXOP). In an embodiment, the broadcast trigger frame in the first PPDU indicates one slot for the station to indicate presence of the station to the AP. In an embodiment, in mono-static backscattering the broadcast trigger frame being carried in the first PPDU announces only one slot for a plurality of stations to each randomly decide to send a respective station identifier in the one slot. In an embodiment, in other than mono-static backscattering the broadcast trigger frame being carried in the first PPDU announces multiple slots for a plurality of stations to each randomly decide to send a respective station identifier in a respective slot.

In another one or more embodiments, an AP is disclosed. The access point (AP) is configured to transmit a first PPDU with a broadcast trigger frame indicating for a station to indicate presence of the station to the AP in a slot of one or more slots announced by the broadcast trigger frame in the first PPDU; receive an indication of the presence of the station in a selected slot of the first PPDU; based on the indication of presence, transmit a second PPDU with a trigger frame indicating for the station to transmit an electronic product code (EPC) of the station in an allocated slot of the second PPDU; receive the EPC of the station in the allocated slot of the second PPDU; transmit a third PPDU with an indication for the station to perform an information request and an indication of an allocated slot in the third PPDU; and receive a response to the information request in the allocated slot of the third PPDU, wherein the AP and the station operate in accordance with Institute of Electrical and Electronics Engineers (IEEE) 802.11bp. In an embodiment, the indication of presence of the station is a 16 bit random number selected by the station or a 16 bit cyclic redundancy check (CRC) of the EPC identifying the station transmitted in the selected slot by a backscattering process. In an embodiment, the second PPDU comprises an IEEE 802.11 preamble and a payload having an IEEE 802.11bp PPDU carrying the trigger frame having a station identifier of the station in a header of the trigger frame to facilitate unicast of the trigger frame to the station. In an embodiment, the station identifier in the header of the frame of the IEEE 802.11bp PPDU is a cyclic redundancy checksum (CRC) of the EPC. In an embodiment, the information request is a write request and the indication of the write request being performed is an acknowledgment that the write request is performed or a negative acknowledgment that the write request is not performed and a reason that the write request is not performed. In an embodiment, the first PPDU and second PPDU are transmitted in a first transmit opportunity (TXOP) and the third PPDU is transmitted in a second TXOP.

In yet another one or more embodiments, a station is disclosed. The station is configured to receive a first PPDU with a broadcast trigger frame indicating for the station to indicate presence of the station to an access point (AP) in a slot of one or more slots announced by the broadcast trigger frame in the first PPDU; transmit an indication of the presence of the station in a selected slot of the first PPDU; receive a second PPDU with a trigger frame indicating for the station to transmit an electronic product code (EPC) of the station in an allocated slot of the second PPDU based on the indication of presence; transmit the EPC of the station in the allocated slot of the second PPDU; receive a third PPDU with an indication for the station to perform an information request and an indication of an allocated slot in the third PPDU; and transmit an indication of the information request being performed by the station in the allocated slot of the third PPDU, wherein the AP and the station operate in accordance with Institute of Electrical and Electronics Engineers (IEEE) 802.11bp.

A few implementations have been described in detail above, and various modifications are possible. The disclosed subject matter, including the functional requests described in this specification, can be implemented in electronic circuit, computer hardware, firmware, software, or in combinations of them, such as the structural means disclosed in this specification and structural equivalents thereof: including potentially a program operable to cause one or more content processing apparatus such as a processor to perform the requests described (such as a program encoded in a non-transitory computer-readable communication medium, which can be a memory device, a storage device, a machine-readable storage substrate, or other physical, machine readable communication medium, or a combination of one or more of them).

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while requests are depicted in the drawings in a particular order, this should not be understood as requiring that such requests be performed in the particular order shown or in sequential order, or that all illustrated requests be performed, to achieve desirable results. In certain circumstances, multitasking and parallel processing may be advantageous. Moreover, the separation of various system components in the implementations described above should not be understood as requiring such separation in all implementations.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed. Other implementations fall within the scope of the following claims.

What is claimed is:

1. A method for information exchange by an access point (AP) and station operating in accordance with Institute of Electrical and Electronics Engineers (IEEE) 802.11bp, the method comprising:
transmitting, by the AP, a first physical layer protocol data unit (PPDU) with a broadcast trigger frame indicating for the station to indicate presence of the station to the AP in a slot of one or more slots announced by the broadcast trigger frame in the first PPDU;
receiving, by the AP, an indication of the presence of the station in a selected slot of the first PPDU;
transmitting, by the AP and based on the indication of presence, a second PPDU to the station with a soliciting frame indicating for the station to perform an operation and transmit a frame in response to performing the operation in an allocated slot of the second PPDU; and
receiving, by the AP, the frame in the allocated slot of the second PPDU from the station.

2. The method of claim 1, wherein transmitting, by the AP, the second PPDU to the station comprises transmitting, by the AP, the second PPDU to the station with the trigger frame indicating for the station to transmit an indication of an electronic product code (EPC) of the station in the allocated slot of the second PPDU based on the indication of presence and receiving by the AP the frame comprises receiving, by the AP, the EPC of the station in the frame of the allocated slot of the second PPDU; the method further comprising:
transmitting, by the AP, a third PPDU with an indication for the station to perform an information request and an indication of an allocated slot in the third PPDU; and
receiving, by the AP, a response to the information request in the allocated slot of the third PPDU.

3. The method of claim 2, wherein the information request is one or more of a write request, read request, and authentication request.

4. The method of claim 2, wherein the information request is a write request and the response to the information request being performed is an acknowledgment that the write request is performed or a negative acknowledgment that the write request is not performed and a reason that the write request is not performed.

5. The method of claim 1, wherein the indication of presence of the station is a 16 bit random number selected by the station or a 16 bit cyclic redundancy check (CRC) of an EPC identifying the station transmitted in the selected slot by a backscattering process.

6. The method of claim 1, further comprising the station randomly deciding to select the slot of the one or more slots indicated by the AP based selecting a random number in a range defined by the first PPDU and comparing the random number to a threshold defined by the first PPDU, the slot being in a first TXOP.

7. The method of claim 1, wherein the second PPDU comprises an IEEE 802.11 preamble and a payload having an IEEE 802.11bp PPDU carrying the trigger frame having a station identifier of the station in a header of the trigger frame to facilitate unicast of the trigger frame to the station.

8. The method of claim 7, wherein the station identifier in the header of the trigger frame is a CRC or a random number.

9. The method of claim 1, wherein the AP and the station are unassociated as defined by an IEEE 802.11 (WiFi) association process.

10. The method of claim 1, wherein the first PPDU and the second PPDU are transmitted in a first transmit opportunity (TXOP).

11. The method of claim 1, wherein the broadcast trigger frame in the first PPDU indicates one slot for the station to indicate presence of the station to the AP.

12. The method of claim 1, wherein in mono-static backscattering the broadcast trigger frame being carried in the first PPDU announces only one slot for a plurality of stations to each randomly decide to send a respective station identifier in the one slot.

13. The method of claim 1, wherein in other than mono-static backscattering the broadcast trigger frame being carried in the first PPDU announces multiple slots for a plurality of stations to each randomly decide to send a respective station identifier in a respective slot.

14. An access point (AP) configured to transmit a first PPDU with a broadcast trigger frame indicating for a station to indicate presence of the station to the AP in a slot of one or more slots announced by the broadcast trigger frame in the first PPDU; receive an indication of the presence of the station in a selected slot of the first PPDU; based on the indication of presence, transmit a second PPDU with a trigger frame indicating for the station to transmit an electronic product code (EPC) of the station in an allocated slot of the second PPDU; receive the EPC of the station in the allocated slot of the second PPDU; transmit a third PPDU with an indication for the station to perform an information request and an indication of an allocated slot in the third PPDU; and receive a response to the information request in the allocated slot of the third PPDU, wherein the AP and the station operate in accordance with Institute of Electrical and Electronics Engineers (IEEE) 802.11bp.

15. The AP of claim 14, wherein the indication of presence of the station is a 16 bit random number selected by the station or a 16 bit cyclic redundancy check (CRC) of the EPC identifying the station transmitted in the selected slot by a backscattering process.

16. The AP of claim 14, wherein the second PPDU comprises an IEEE 802.11 preamble and a payload having an IEEE 802.11bp PPDU carrying the trigger frame having a station identifier of the station in a header of the trigger frame to facilitate unicast of the trigger frame to the station.

17. The AP of claim 16, wherein the station identifier in the header of the frame of the IEEE 802.11bp PPDU is a cyclic redundancy checksum (CRC) of the EPC.

18. The AP of claim 14, wherein the information request is a write request and the indication of the write request being performed is an acknowledgment that the write request is performed or a negative acknowledgment that the write request is not performed and a reason that the write request is not performed.

19. The AP of claim 14, wherein the first PPDU and second PPDU are transmitted in a first transmit opportunity (TXOP) and the third PPDU is transmitted in a second TXOP.

20. A station configured to receive a first PPDU with a broadcast trigger frame indicating for the station to indicate presence of the station to an access point (AP) in a slot of one or more slots announced by the broadcast trigger frame in the first PPDU; transmit an indication of the presence of the station in a selected slot of the first PPDU; receive a second PPDU with a trigger frame indicating for the station to transmit an electronic product code (EPC) of the station in an allocated slot of the second PPDU based on the indication of presence; transmit the EPC of the station in the allocated slot of the second PPDU; receive a third PPDU with an indication for the station to perform an information request and an indication of an allocated slot in the third PPDU; and transmit an indication of the information request being performed by the station in the allocated slot of the third PPDU, wherein the AP and the station operate in accordance with Institute of Electrical and Electronics Engineers (IEEE) 802.11bp.
